(19) United States
(12) Patent Application Publication
(10) Pub. No.: US 2007/0096853 A1
(43) Pub. Date: May 3, 2007

(54) Indirect power-linking device

(75) Inventors: Alex Hong, Kaohsiung City (TW); Masaharu Miyahara, Kaohsiung City (TW)

Correspondence Address: BACON & THOMAS, PLLC, 625 SLATERS LANE, FOURTH FLOOR, ALEXANDRIA, VA, 22314, US

(73) Assignee: Sunonwealth Electric Machine Industry Co., Ltd., Kaohsiung City (TW)

(21) Appl. No.: 11/272,678

(22) Filed: Nov. 15, 2005

(30) Foreign Application Priority Data
Oct. 31, 2005 (TW) 94138099

(51) Int. Cl. H01H 9/00

(52) U.S. Cl. 335/207

(57) ABSTRACT

The invention relates to an indirect power-linking device, which are disposed respectively the magnets at the locations where correspond to a power-driving device and a power-driven device that mutually attract. The magnets shall have at least one N pole and one pole. Therefore, when the power-driving device rotates, the magnetic field lines between the magnets of the power-driving device and the power-driven device are distorted to generate a suppressive effect in formation of a rotational torque. The rotational torque can drive the power-driven device and the power-driving device to generate a synchronous and powerful operation.

### FIELD OF THE INVENTION

The invention relates to an indirect power-linking device, which is applied to the indirect power transmission between a power-driving device and a power-driven device so that the power-driven device generates a powerful operation driven by the traction of the power-driving device.

### BACKGROUND OF THE INVENTION

As shown in FIG. 1, Taiwan Patent Application No. 94130223 discloses a cooling device. The cooling device includes a cooling fan 50 and a heat sink 21. The heat sink 21 directly contacts with a heating element 81 to absorb the heat therefrom. The cooling fan 50 is disposed on the heat sink 21 to dissipate heat.

The heat sink 21 contains a central heat conducting body 22. A plurality of cooling fins 23 extend from the periphery of the central heat conducting body 22. The central heat conducting body 22 has an absolutely sealed and hollow chamber 221 therein. The chamber 221 is filled with a cooling liquid and disposed an agitator 25. The locations corresponding to the agitator 25 and a rotor of the cooling fan are disposed the permeability components 251 & 54, and the magnetic attraction and mutual traction exist between the permeability components 251 & 54.

As a result, by means of the synchronous operation magnetically drawn by a rotor 53 and the agitator 25, the cooling liquid carrying heat in the chamber 221 is agitated by the rotation of the agitator 25 so as to result in better cooling effect. Meanwhile, the chamber 221 remains as a fully sealed space without having the overflow issue of the cooling liquid.

Accordingly, the permeability components 251 & 54 are the crucial design for the rotor 53 and the agitator 25 to exhibit the indirect linking operation. As such, based on the spirit striving for perfection, the invention specifically targets at the indirect linking device for further improvement so that those driven devices similar to the agitator 25 generate synchronous and more powerful operation driven by the traction of power source, attaining the optimal cooling effect.

### SUMMARY OF THE INVENTION

In view of this, the present invention provides an indirect linking device, which includes a power-driving device and a power-driven device. The locations where correspond to the power-driving device and the power-driven device mutually dragging are disposed respectively with magnets necessarily having at least two magnetic poles, such as N pole and S pole.

Consequently, when the power device rotates, the magnetic field lines between the magnets of the power-driving device and the power-driven device are distorted to result in the suppressive effect, further forming a rotational torque to drive and synchronously rotate the power-driven device as a result of the magnetic traction of the power device.

If the power-device pertains to the preferred embodiment of a rotor of a cooling fan and the power-driven device pertains to the preferred embodiment of a cooling liquid agitator, the agitator generates a powerful operation arising from the torque formed by the suppressive effect of the magnetic field lines and the indirect magnetic traction of the rotor, so as to agitate the cooling liquid. The cooling liquid absorbing heat becomes a dynamic hot liquid that uniformly diffuses and conducts the heat to each cooling fin to facilitate the heat dissipation of the fan, achieving a faster and more efficient cooling effect.

### BRIEF DESCRIPTION OF THE DRAWINGS

FIG. 1 is a cross-sectional schematic view of the conventional structure;

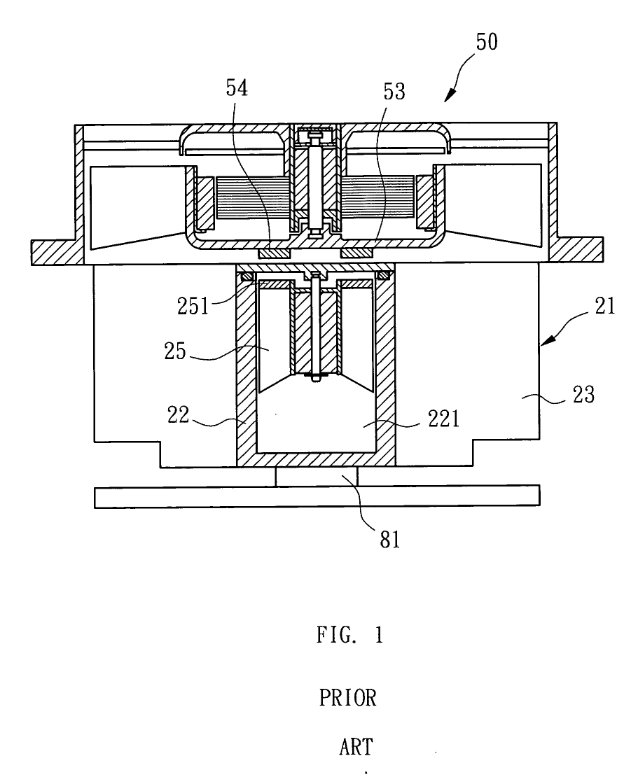

FIG. 2 is a cross-sectional schematic view showing the first structure of the present invention;

FIG. 3 is a partially exploded view showing the first structure of the present invention;

FIG. 4 is a partially exploded view showing the second structure; and

FIG. 5 is a cross-sectional view showing the preferred embodiment of the present invention.

### DETAILED DESCRIPTION OF THE PREFERRED EMBODIMENTS

The invention relates to an indirect power-linking device, which has magnets disposed respectively at the locations where corresponds to a power-driving device and a power-driven device mutually drag. The magnets disposed respectively at the power-driving device and the power-driven device all have at least two magnetic poles so as to make the power-driving device and the power-driven device operate synchronously and generate powerful operation, achieving the optimal cooling effect.

Listed below are several preferred embodiments depicting the respective position of each part in the present invention.

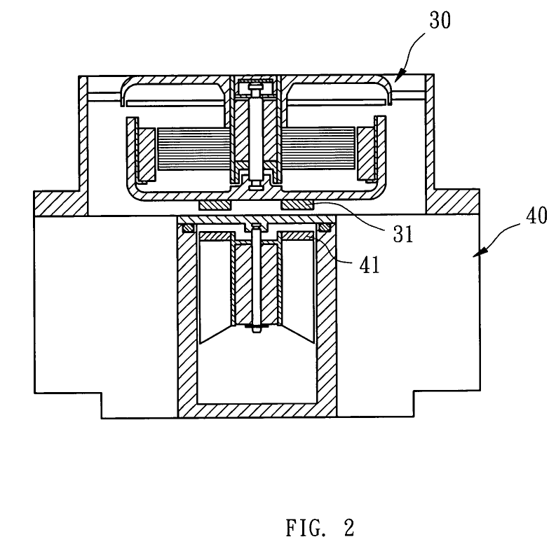

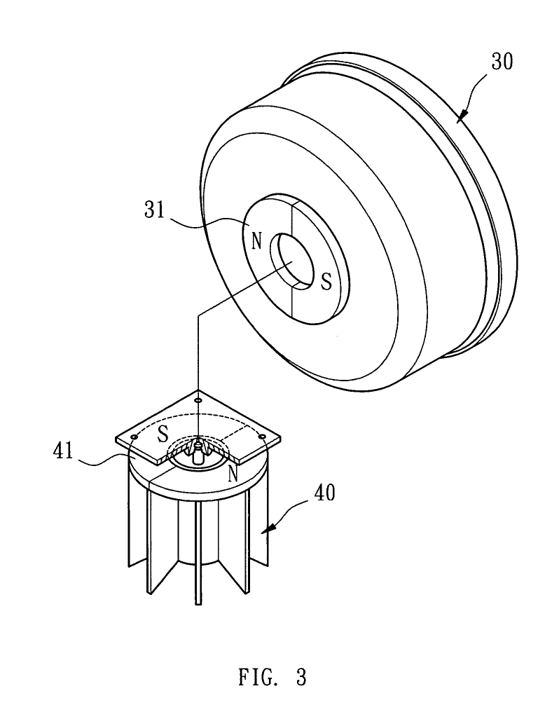

Please also refer to FIG. 2 and FIG. 3 containing a power-driving device 30 and a power-driven device 40, wherein the magnets 31, 41 are disposed at the locations where corresponds to the power-driving device 30 and the power-driven device 40 mutually dragging, and all have at least two magnetic poles, e.g. N pole and S pole. The magnets 31, 41 may take a form of a one-piece ring and a ring assembled by a plurality of rectangular plates.

When the power-driving device 30 is in a still state, the N pole of the magnet 31 of the power-driving device 30 attracts the S pole of the magnet 41 of the power-driven device, and the S pole of the magnet 31 of the power-driving device 30 attracts the N pole of the magnet 41 of the power-driven device 40. When the power-driving device 30 is rotating, the magnetic field lines between the magnet 31 of the power-driving device 30 and the magnet 41 of the power-driven device 40 are distorted to generate a suppressive effect further forming a rotational torque. The rotational torque drives the power-driven device 40 to synchronously rotate and generate a powerful operation due to the magnetic traction of the power-driving device 30.

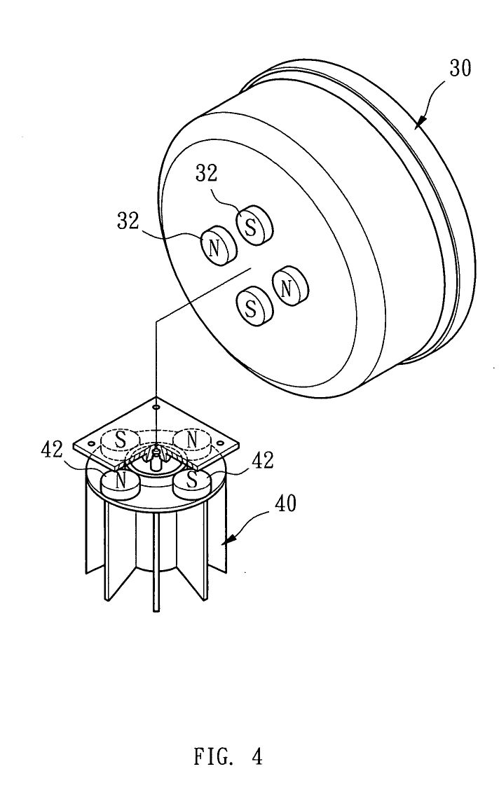

Besides, the present invention can be the structural design as shown in FIG. 4. The power-driving device 30 and the power-driving device 40 are disposed at least two (four in FIG. 4) magnets 32, 42 respectively, and the magnets 32, 42 are located at the positions where correspond to the power-driving device 30 and the power-driven device 40 that mutually drag.

The magnet 32 of the power-driving device 30 shall have at least an N pole and an S pole and are arranged in an alternative N-S-N-S ring alignment. The magnet 42 of the power-driven device 40 shall also have at least an N pole and an S pole and are also arranged in an alternative N-S-N-S ring alignment. In addition to the circular design shown in FIG. 4, the magnets 32, 42 can be also formed as a ring assembled by the rectangular plates.

Therefore, when the power-driving device 30 rotates, a torque drives the power-driven device 40 to rotate as a result of the suppressive effect generated by distorting the magnetic field lines. By means of the magnetic traction, the power-driven device 40 and the power-driving device 30 generate a synchronous and powerful operation.

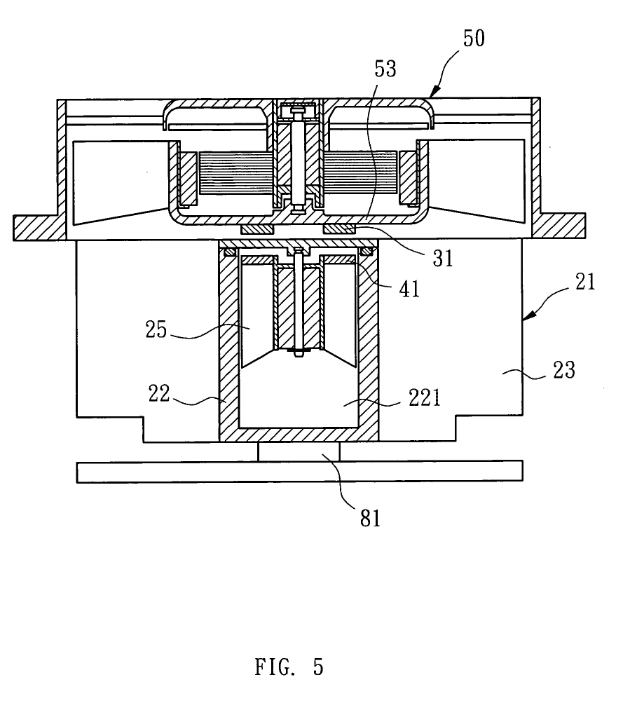

Furthermore, FIG. 5 is a schematic view showing the embodiment of the present invention. The power-driving device could be a motor of a cooling fan 50 and the power-driven device could be an agitator 25 of a cooling device 21.

The cooling device 21 includes a central heat conducting body 22 and a plurality of cooling fins 23 extending from the periphery thereof. The bottom of the central heat conducting body 22 is directly in contact with a heating element 81 and an absolutely sealed hollow chamber 221 is formed therein. The chamber 221 is filled with a cooling liquid and the agitator 25 is disposed in the chamber 221.

The magnets 31, 41 are disposed between a rotor 53 of the cooling fan 50 and the agitator 25 and shall be located at the locations to which mutually correspond and have magnetic poles with at least two polarities, such as N and S poles.

As such, when the rotor 53 of the cooling fan 50 rotates, the magnetic field lines between the magnet 31 of the rotor 53 and the magnet 41 of the agitator 25 are distorted in generation of a suppressive effect so as to further form a rotational torque for driving the agitator 25 and the rotor 53 to generate a synchronous and powerful operation. The agitator 25 can agitate the cooling liquid filled in the chamber 221 so that the cooling liquid absorbing heat becomes a dynamic hot liquid and immediately and uniformly diffuses and conducts heat to each cooling fin 23 to facilitate the heat dissipation of the cooling fan 50, achieving a faster and more efficient cooling effect.

In sum, by means of the indirect magnetic traction between the power-driving device and the power-driven device, the invention brings about the faster and better cooling effect while the chamber remains as a fully sealed space, ruling out the issue of the cooling liquid overflow and affecting no operational speed of the cooling fan. Therefore, the present invention not only has a novelty and a progressiveness, but also has an industry utility.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the specification, appended claims or figures, which are to be accorded with the broadest interpretation so as to encompass all such modifications and similar structures.

What is claimed is:

1. An indirect power-linking device, comprising a power-driving device and a power-driven device having respective magnets disposed thereon with at least a N pole and a S pole so as to mutually attract.

2. The indirect power-linking device of claim 1, wherein said power-driving device and said power-driven device are disposed respective magnets having at least two magnetic poles.

3. The indirect power-linking device of claim 1, wherein said power-driving device and said power-driven device are disposed respectively at least two magnets with different magnetic poles.

4. The indirect power-linking device of claim 3, wherein said power-driving device and said power-driven device are disposed respectively four magnets aligned in form of an alternative N-S-N-S ring.

5. The indirect power-linking device of claim 1, wherein said power-driving device is a fan motor.

6. The indirect power-linking device of claim 1, wherein said power-driven device is an agitator for cooling liquid.

7. The indirect power-linking device of claim 1, wherein said magnets are aligned in an annular form.

8. The indirect power-linking device of claim 1, wherein said magnets are formed by a plurality of rectangular sheets.
